(19) United States
(12) Patent Application Publication
(10) Pub. No.: US 2006/0060279 A1
(43) Pub. Date: Mar. 23, 2006

(54) Vehicle wheel

(76) Inventors: Sven Arthur Jansson, Mariehamn (FI); Karl-Johan Edlund, Mariehamn (FI)

Correspondence Address: CHARLES E. BAXLEY, ESQ., 90 JOHN STREET, THIRD FLOOR, NEW YORK, NY, 10038, US

(21) Appl. No.: 10/544,943

(22) PCT Filed: Feb. 6, 2004
(86) PCT No.: PCT/SE04/00156

§ 371 Date: Aug. 8, 2005

(30) Foreign Application Priority Data
Feb. 13, 2003 (SE) 0300382-9

(51) Int. Cl. B60C 5/20

(52) U.S. Cl. 152/331.1

(57) ABSTRACT

A vehicle wheel with inflatable tyres, mounted on the same rim. One of the tyres (1), called a summer tyre, has tread suitable for summer use and at least one additional tyre (10), called a winter tyre, with a tread suitable for winter use. The winter tyre (or tyres) is mounted on the side of the summer tyre and is, in summer conditions, not fully inflated and hence not in contact with the road surface, because its circumference in its semi-inflated state has a shorter radius than that of the circumference of the summer tyre. The winter tyre (10) is securely attached to the outer surface of a concentric volume accumulator (7), which is part of the wheel rim and functions as a constantly available spare tyre. When inflated, the winter tyre (10) can expand, so that it has the same outer radius as the summer tyre (1) and thus also comes into contact with the road surface. After that, the pressure of the summer tyre is lowered and the area of contact with the road surface is redistributed to the winter tyre (or tyres).

### TECHNICAL BACKGROUND

The present invention is of a vehicle wheel with at least two tyres mounted on the same rim.

For most vehicles one spare tyre is normally necessary as well as a set of tyres for winter use, so-called winter tyres, one for each wheel.

These tyres are used when necessary and are quite awkward to mount on the rim. Heavy lorries may also have two tyres on the same wheel or, sometimes, a pair of wheels on an additional axle which can be brought into contact with the road surface when necessary.

The present invention is of a system for lighter vehicles in which both spare tyres and winter tyres are always on the vehicle and can be simply brought into operation even during a journey without stopping. Proposals have been made of various systems of using two air chambers in one and the same tyre to improve safety, as well as systems of projectable studs for winter driving.

In the German patent description DE 19860564 A1 there is a description of a tyre with an internal partition and a tread containing a number of rubber studs which are pushed out by compressed air from a duct underneath it. This system leads to poor sideways stability when one of the two internal chambers is punctured. The point of contact with the road surface shifts sideways, which complicates the balance of the steering action. Attaching the studs to a large number of little “cushions” is complicated and if one stud comes loose, there is the risk that the whole air system is punctured.

The patent description DE 4140102, too, shows a tyre with a partition and the aim is to keep one of the air chambers functioning if the other is punctured. Still, there is the risk of poor sideways stability and steering problems.

In the patent description U.S. Pat. No. 6,244,666 B1 there is a special winter tyre with studs which is mounted between two ordinary tyres, as is normal on the rear wheels of lorries, but one variant has a winter tyre next to a single ordinary tyre. The winter tyre (or tyres) is only meant to prevent skidding, in the manner of a snow chain, while the weight of the lorry is carried by the ordinary tyres. The winter tyre is brought into contact with the road by radial expansion through inflation, which is made possible by the corrugated shape of the side walls, which is also included in the patent application SE9906/72. The winter tyre is stabilized sideways by the support of the adjacent ordinary tyres or of an additional supporting wall, if there is only one ordinary tyre. When the pressure of the ordinary tyres is low or when one of them has been punctured, the winter tyre is unlikely to have sufficient sideways stability, and the steering geometry will also be affected. The winter tyre is also likely to be strongly affected by the centrifugal force with the result that it is pushed out even when it is not filled with air in a way that may upset the weight symmetry of the whole tyre. In the patent description DT 2600797 there is a tyre with studs which are projected by air pressure from a hose behind the studs. Our comments on DE 19860564 also apply here. A similar system with projectable studs is described in U.S. Pat. No. 3,665,992, but in this case the projection is caused by the ordinary tyre pressure, which will lead to quite uncontrollable activation of the studs, for example, when the temperature changes.

### BACKGROUND OF INVENTION

It is well known that there is today a regulation in the Nordic countries Finland, Sweden, Norway, Denmark and Iceland that requires the use of winter tyres (studded tyres or friction tyres) during the four-month period from 1st December to 31st March, except on gritted or salted roads, whether they are necessary or not. The restoration of the worn-down roads every spring to their normal groove-free condition in these countries runs to a cost of 428,000,000 euros; damage to vehicles for the same period amounts to 421,000,000 euros and personal injury costs to 631,000,000 euros, making a total of 1480,000,000 euros, plus the road salt, which is harmful both to the environment and to vehicles. Material resulting from the friction of rubber against tarmac, ice and snow tend to cover the windows of vehicles with a film which obscures the driver's vision in the daytime when the sun is low and ahead, in the winter season, in the Nordic countries.

Salty melted snow increases the risk of aquaplaning in the concave grooves of the road surface, which, in the province of Norrland, is increased by worn-down ice edges. The salt lowers the freezing point to 8-9 degrees centigrade, but refrozen salt-saturated slush often forms false surfaces on the road. Today's winter tyres are relatively good when new, but they quickly deteriorate because they are often used on bare tarmac, which contributes to a higher noise level, greater fuel consumption and road wear. This situation is due to the law which requires the use of winter tyres during a four-month period.

### SUMMARY OF INVENTION

The aim of the invention is improve a vehicle wheel with at least two inflatable tyres mounted on the same rim, which is achieved when the wheel is constructed with the characteristics included in the patent claims below.

The present invention is of a conventional radial tyre, called a summer tyre, integrated with at least one winter tyre mounted on the same rim, so that the latter remains passive with a roll radius that is considerably smaller than that of the summer tyre with which it is parallel. The following description is of a system with at least two winter tyres, one mounted symmetrically on either side of the conventional summer tyre on the same rim. However, we assume that only one winter tyre can be used, at least on non-steering wheels. When only one winter tyre is used, this tyre and the summer tyre will have points of contact with the road surface at different distances from the common vertical line of symmetry of the two tyres. This results in torque in relation to the line of symmetry of a varying direction and strength, depending on which of the tyres is in active use. In such cases there are likely to be problems if the tyres are mounted on wheels, usually the front wheels, which are used for steering.

### DESCRIPTION OF INVENTION

In the description of the invention we refer to the following drawings:

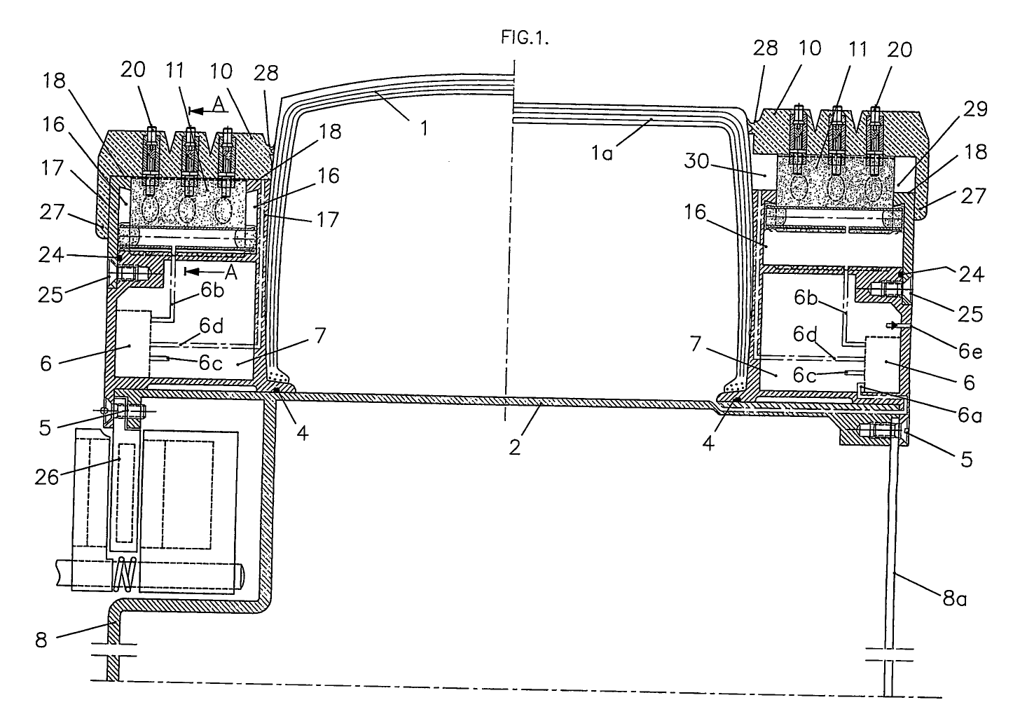

FIG. 1 shows a cross section of a wheel on which are mounted one summer tyre and two winter tyres.

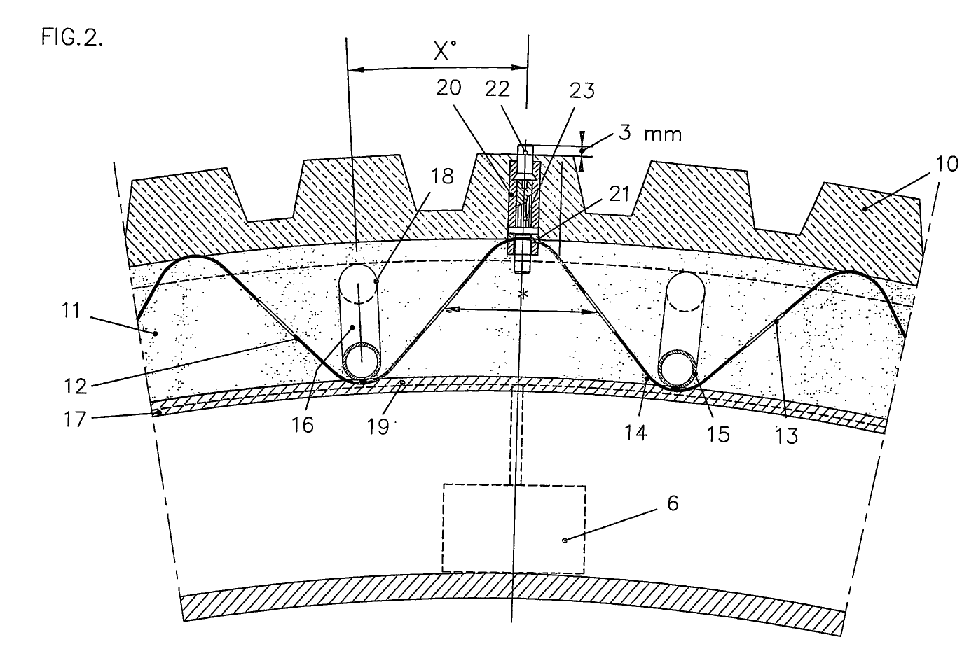

FIG. 2 shows a section along the line A-A in FIG. 1 through one of the winter tyres.

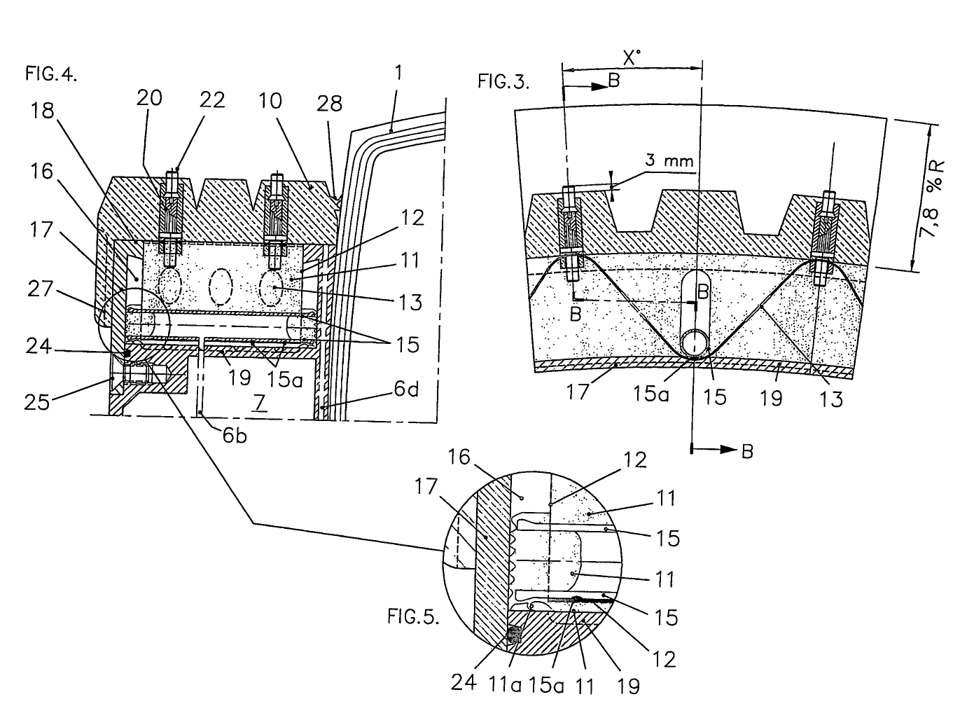

FIG. 3 shows a section like that in FIG. 2 through an unactivated winter tyre.

FIG. 4 shows a section along the line B-B in FIG. 3.

FIG. 5 shows the circled part of FIG. 4 in detail on a larger scale.

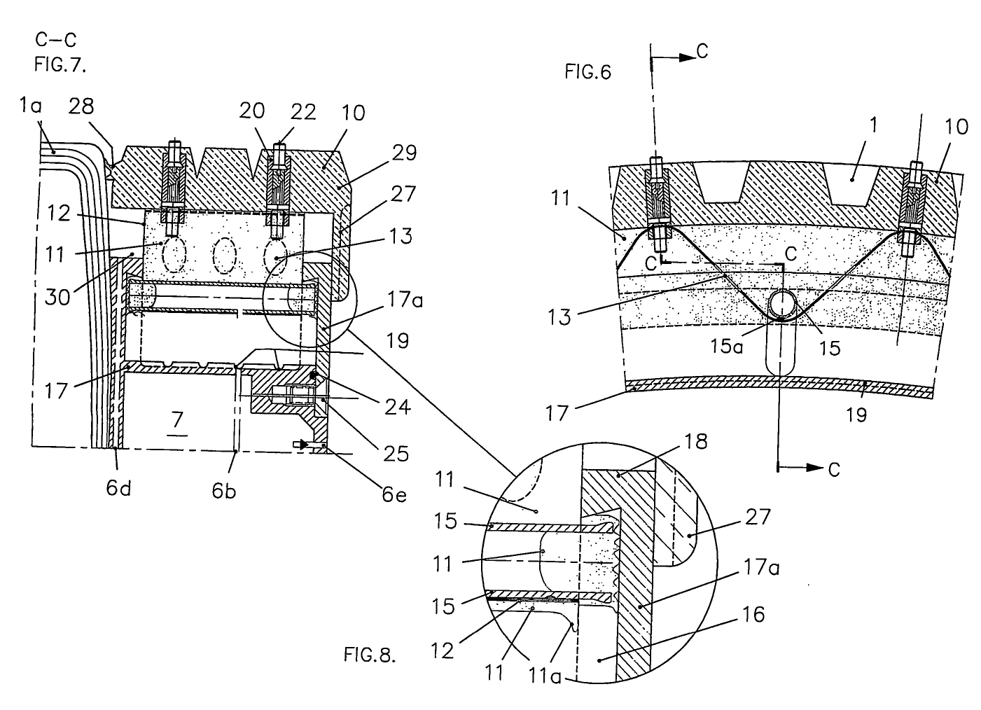

FIG. 6 shows a section like FIG. 3 with the winter tyre activated.

FIG. 7 shows a section along the line C-C in FIG. 6.

FIG. 8 shows the circled part of FIG. 7 in detail on a larger scale.

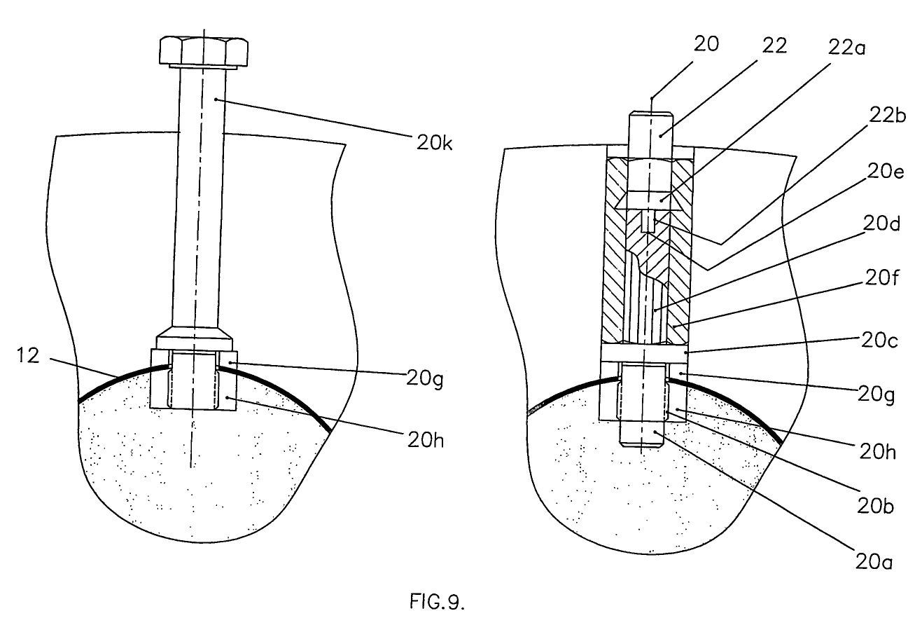

FIG. 9 shows the mounting of the studs on the winter tyre in detail on a larger scale.

FIG. 1 shows a combined summer and winter tyre where the latter can also be a stud tyre and a spare tyre. The two types of tyre can be active separately or simultaneously and are always available. The air pressure can be redistributed between the two tyres depending on the level of road friction. The summer tyre 1 of a conventional radial type is mounted in the centre of the rim 2 in order to enhance steering balance. The rim 2 carries an outer and an inner combined side-locking ring and a concentric volume accumulator 7, which, by means of the o-ring gasket 4 and the screw joint 5, centrally fixes the tubeless summer tyre airtight onto the rim 2. Valves 6 can be connected to the volume accelerators. If necessary, horse-shoe shaped balancing weights can be fixed in the recesses on the inside of the flange joint 5. The winter tyre 10, whose width in the present case can be about 32 percent of that of summer tyre 1, is constructed as follows:

A reinforced cross-country tread or similar, a wave-shaped spring band 12 (FIG. 2) with light holes in the neutral zone as well as axial circular tubular rods 15 spot-welded to the steel band 12. The rubber-filled tubular rods 15 follow the radial rim grooves 16 at radial expansion right up to the rim bracket 18, which also has an axial locking profile which tightens against the tubular rod 15, which is coated with vulcanised rubber 11 outside and inside. The spring steel band is the expanding body of the winter tyre, in whose manufacturing process the filler rubber 14 and the tread 10, which is vulcanised to the steel band, are given a circular band shape with axial tightening and peripheral pre-tension, i.e. it is already to some extent expanded, on the volume accumulator 7. The rubber contains no textile cord and is therefore able to expand radially_and peripherally at the same rate as the steel band 12. The slightly softer rubber substance 11 has good vulcanisation contact through the light holes 13 in the spring steel band, thereby preventing the spring steel band 12 from buckling axially in the neutral zone 13. The rubber substance 11, the steel profile 12, the tubular rods 15 and the rim bracket 18 in conjunction give the winter tyre very good radial and axial stability.

The rubber substance 11 has tightening lips 11a, concentric towards the ends, turned inwards towards the side of the pressure. The concentric rubber edge 27 has radial grooves in the rubber in order to increase its plasticity when expanding and to keep the outer space 29 between the wear surface 10 and the wheel cover 17 clean, and to protect the side-locking ring 17. The tightening lip 28 keeps the inner space 30 between the wear surface 10 and the summer tyre 1 or 1a clean. The emission of air 6d from the valves 6 has an outlet 6d via the inner space 30 and it helps to keep it clean.

The tyre stud 20 is constructed as follows, starting from the inside:

A cylindrical central dowel, consisting of a cylindrical pin, d=4 mm, 20a, an M5 thread 20b, a stopping bracket 20c, a grooved cylindrical part d=4 mm 20d, finished with a end hole d=3 mm 20a, all of it in stainless material. A hard metal peg 22, d=3 mm, has a conical head 22a at the bottom end and a steering pin d=3 mm, 22b, which fits into the end hole 20e of the central dowel. The central dowel and the metal peg are enclosed by an aluminium casing 20f, which is pressed around the central dowel 20d and the metal peg 22. The aluminium casing 20f is thus given a hexagonal outer profile, which facilitates the mounting operation and stops it unscrewing itself.

Fixing and mounting the tyre studs 20: The stud 20 goes through the tread through a plane-concave perforated strip 20g, which lies axially on the steel profile's 12 positive bend, through a hole d=5.2 mm in the steel profile 12, and its lower threaded dowel is screwed into a convex-plane strip 20h, which lies axially under the steel profile's 12 positive bend. The holes in the steel profile have a successive axial shift alignment, which results in the stud only going in the same rotational track at intervals. Before vulcanisation, the strips are fixed in an axial direction with a teflon-coated blind stud 20k, which has a bracket and a threaded dowel. After vulcanisation, the threaded strip 20h and the perforated strip 20g are fixed, after which the blind stud is unscrewed, leaving a hole in the rubber which leads to the threaded strip. If necessary, the stud 20 can be replaced. The stud can be screwed in and out by means of a torque wrench and a little silicone grease. If the winter tyres are used in the Nordic countries, they are provided with studs, elsewhere they can be used as cross-country, friction or spare tyres.

In order to enable the winter tyre 10 to be mounted on the outer surface of the concentric volume accumulator, the outer part of the rim 17 may be dismantled by means of a screw connection 25 and an o-ring gasket 24. The winter tyre will remain steadily on the outer surface even when exposed to centrifugal power at high speed. The winter tyre is first mounted on a radial fixture where the pre-tension can be adjusted, so that the winter tyre can be pushed across onto the outer surface of the volume accumulator 7. The outer surface has a half-open concave check pattern 19, which facilitates the filling and the emptying of the tyre. The total power working radially on the winter tyre when inflated equals 1970 kp plus centrifugal power when rotating. Pressure adjustment can be carried out when the car is running if necessary. If there is a risk of aquaplaning or if one wants to reduce rolling friction, the pressure of the summer tyre should be increased and if the driver wants a slow comfortable ride on cobbled streets, the air pressure of the summer tyre can be lowered.

The tyres are controlled as follows:

If road conditions require the use of winter tyres, a valve in unit 6 is opened, so that duct 6 opens and air passes direct through an inlet duct 6b to the winter tyre. At this point the pressure of the summer tyre should be lowered somewhat, so that the grip of the winter tyres is strengthened. Through a second valve in unit 6 a duct 6a opens into the summer tyre towards the outlet duct 6d and the pressure of the summer tyre against the road lessens. Conversely, when the tyre use is the opposite of the above, the opposite procedure is employed. When, in the summer season, a higher pressure in the summer tyre is necessary, air can be led from the volume accumulator to the summer tyre through a valve in unit 6.

There are systems on the market for the continuous monitoring of tyre pressure as well as for alerting the driver when the pressure is too low. There are also systems which automatically adjust the pressure while the vehicle is running. We take it as understood that such systems for controlling and monitoring tyres can also be applied to the present invention. Otherwise, the pressure of the volume accumulator can be adjusted at a service station.

Slippery road conditions derive from the following factors: air temperature, road temperature, relative air humidity as well as the relation between torque against the road and friction torque. The advantage of having a summer tyre and two constantly available winter tyres is that it enables the driver to inflate the winter tyres early in the morning and increase their air pressure, as necessary, by lowering the pressure of the summer tyre. Main roads, as a rule, are not slippery but country lanes and feeder roads can be treacherous. As the winter tyres are available, they can be manually activated and used when necessary or automatically activated when the slippery road conditions are fulfilled. If the summer tyre is punctured, the wheel goes down to a roll radius which is about 25 mm less than normal, until the driver has activated the combined summer and spare tyres enough to expand to a full radius. The driver can then drive on to the nearest service station without causing traffic congestion or further damage to the summer tyre. The integrated tyres can also be used, in an upgraded model, on lorries and buses, and also as constantly available cross-country and spare tyres. The integrated tyres reduce road wear, increase safety and, hopefully, reduce the use of road salt, which would be a great benefit for the environment.

Our aim is to bring the tyres into use, as required by climatic and geographical conditions, by inflation with an air pump at a service station or, automatically, by a driver-controlled system. There are systems on the market for monitoring tyres while a vehicle is running. There have been proposals regarding warning systems for low tyre pressure and legislation relating to this is in preparation. The next step is therefore, naturally, to enable tyre pressure to be controlled by the driver. This is made possible by the present invention.

The ability to regulate the paw pressure while driving, i.e. the pressure in the contact surface between tyre and road, depending on speed and weight, can reduce fuel consumption by as much as 10% and will also increase safety considerably.

Of course the type of tyre and wheel construction that we have described is only an example of how the present invention can be realized and changes can be introduced without departing from the essential concept of the invention. Thus all the measurements listed are only examples of dimensions of the invention and may be changed depending on the size, weight and other properties of the vehicle on which the wheel is going to be used.

Non-steering wheels can use one winter tyre of the type mentioned, whose width is 64% of the width of the summer tyre, and the winter tyre is mounted on the inside of the summer tyre. The outer side-locking ring has o-ring gaskets and can be dismantled in order to facilitate the change of the summer tyre without disturbing the spare or winter tyre.

1. A vehicle wheel with at least two inflatable tyres mounted on the same rim, one of which (1), called a summer tyre, has a tread suitable for summer use and at least one additional tyre (10), called a winter tyre, with a tread suitable for winter use. The winter tyre (or tyres) is mounted on the side of the summer tyre and is not inflated in summer conditions and thus not in contact with the road surface, as the radius of its outer periphery is shorter than that of the summer tyre. When inflated, the winter tyre (10) can expand to reach the same outer radius as the summer tyre (1), so that it also comes into contact with the road surface and the air pressure of the summer tyre is reduced, thereby redistributing the contact surface with the road to the winter tyre (or tyres). The vehicle wheel is characterized by the so-called winter tyres 10) being reinforced with a wave-shaped spring steel band (12) cast in the rubber substance (11). The spring steel band (12) has tube-shaped circular steering pins (15), whose outer ends run in radial grooves (16) in the sides of the rim and whose radial movement, when the tyre expands, is restricted by a bracket turned inwards (18) on the sides of the rim.

2. A vehicle wheel according to claim 1, characterized by studs (20) fixed in the spring steel band (12) of the winter tyre (10) which consist of a hard metal dowel (22) shrink-fixed into a socket (20) fixed to the steel band (12) with an anchor screw (21).

3. A vehicle wheel according to claim 1, characterized by the part of the rim on which the winter tyres are mounted being shaped to function as a volume accumulator (7) for compressed air to be used to inflate either of the tyres mounted on the rim.

4. A vehicle wheel according to claim 3, characterized by valves (6a, 6b, 6c) being placed next to the volume accumulator (7) for compressed air to regulate the air pressure of the tyres and to enable the volume accumulator to be filled.

5. A vehicle wheel according to one of claims 1 to 4, characterized by the rubber substance (11) and the tread (10) being vulcanised to the steel band (12) and lacking a textile cord, so that they can expand together with the steel band when the tyre is being inflated and expanded.

6. A vehicle wheel according to claim 3 or 4, characterized by the wheel rim (17) on which the winter tyres are mounted having an outer surface with a concave check pattern (19) in order to distribute the air when filling and emptying the tyres.

7. A vehicle wheel according to claim 3 or 4, characterized by the winter tyre (10) being securely mounted on the outer surface of the volume accumulator and functioning as a constantly available spare tyre.
